(19) United States
(12) Patent Application Publication
(10) Pub. No.: US 2023/0378822 A1
(43) Pub. Date: Nov. 23, 2023

(54) WIRELESS POWER TRANSFER PROFILES

(71) Applicant: Apple Inc., Cupertino, CA (US)

(72) Inventors: Zaid A AbuKhalaf, Sunnyvale, CA (US); Alin I Gherghescu, Campbell, CA (US); Jukka-pekka J Sjoeroos, Cupertino, CA (US)

(21) Appl. No.: 18/192,183

(22) Filed: Mar. 29, 2023

Related U.S. Application Data
(60) Provisional application No. 63/364,817, filed on May 17, 2022.

(51) Int. Cl. H02J 50/80; H02J 50/10; H02J 7/00

(52) U.S. Cl. CPC H02J 50/80; H02J 50/10; H02J 7/0048; H02J 2207/20

(57) ABSTRACT

A wireless power transmitter can include a wireless power transfer coil, an inverter that receives an input DC voltage and outputs an AC voltage to the wireless power transfer coil so as to deliver power to a wireless power receiver, and a communications module configured to communicate with the wireless power receiver by transmitting and receiving messages requesting, selecting, or confirming one of a plurality of power profiles of the wireless power transmitter, the plurality of power profiles corresponding to a gain measurement mode, a nominal mode that delivers a relatively higher power level, and a light load mode that delivers a relatively lower power level.

### CROSS-REFERENCE TO RELATED APPLICATIONS

This application claims priority to U.S. Application No. 63/364,817, entitled “Wireless Power Transfer Profiles,” filed May 17, 2022, which is hereby incorporated by reference in its entirety for all purposes.

### BACKGROUND

Wireless power transfer (“WPT”), such as inductive power transfer (“IPT”), may be used to provide power for charging various battery-powered electronic devices. One application in which WPT has seen increases in use is the consumer electronics space around devices such as mobile phones (i.e., smart phones) and their accessories (e.g., wireless earphones, smart watches, etc.) as well as tablets and other types of portable computers and their accessories (e.g., styluses, etc.).

### SUMMARY

A wireless power transmitter can include a wireless power transfer coil, an inverter that receives an input DC voltage and outputs an AC voltage to the wireless power transfer coil so as to deliver power to a wireless power receiver, and a communications module configured to communicate with the wireless power receiver by transmitting and receiving messages requesting, selecting, or confirming one of a plurality of power profiles of the wireless power transmitter, the plurality of power profiles corresponding to a gain measurement mode, a nominal mode that delivers a relatively higher power level, and a light load mode that delivers a relatively lower power level.

The wireless power transmitter can be further configured to set an operating mode of the wireless power transmitter responsive to a message received from the wireless power receiver selecting a power profile corresponding to the operating mode. The wireless power transmitter can be further configured to confirm the set operating mode by transmitting an acknowledgement message to the wireless power receiver in response to the message received the wireless power receiver selecting a power profile corresponding to the operating mode. The wireless power transmitter of can be further configured to request a temporary interruption of wireless power transfer if the message received from the wireless power receiver selecting the power profile corresponding to the operating mode selects an operating mode for which a change of the input DC voltage is desired. The wireless power transmitter can be further configured to temporarily interrupt wireless power transfer responsive to a message received from the wireless power receiver requesting a temporary interruption of wireless power transfer. The wireless power transmitter can be further configured to request an operating mode of the wireless power transmitter by sending a message requesting a power profile corresponding to the operating mode to the wireless power receiver. The wireless power transmitter can send a message requesting the light load profile responsive to a high temperature condition of the wireless power transmitter.

A wireless power receiver can include a wireless power transfer coil, a rectifier that receives an input AC voltage induced in the wireless power transfer coil by a wireless power transmitter and outputs a DC voltage, and a communications module configured to communicate with the wireless power transmitter by transmitting and receiving messages requesting, selecting, or confirming one of a plurality of power profiles of the wireless power transmitter, the plurality of power profiles corresponding to a gain measurement mode, a nominal mode that delivers a relatively higher power level, and a light load mode that delivers a relatively lower power level.

The wireless power receiver can be further configured to send a message selecting an operating mode of the wireless power transmitter responsive to a message received from the wireless power transmitter requesting a power profile corresponding to the operating mode. The wireless power receiver can be further configured to send a message selecting a power profile corresponding to an operating mode of the wireless power transmitter based at least in part on a state of charge of a battery in the wireless power receiver. The wireless power receiver can send a message selecting a power profile corresponding to the light load mode if the state of charge of the battery is high. The wireless power receiver can send a message selecting a power profile corresponding to the nominal mode if the state of charge of the battery is low.

A method, performed by a wireless power transmitter, can include receiving a message from the wireless power receiver selecting a power profile corresponding to an operating mode of the wireless power transmitter, setting the operating mode of the wireless power transmitter responsive to the received message, and sending a message to the wireless power receiver confirming the power profile. The power profile can be selected from the group consisting of a gain measurement mode profile, a low power mode profile, and a nominal mode profile.

The method can further include, prior to receiving the message from the wireless power receiver selecting the power profile corresponding to the operating mode of the wireless power transmitter, sending a message to the wireless power receiver requesting the power profile corresponding to the operating mode of the wireless power transmitter. Sending a message to the wireless power receiver requesting the power profile corresponding to the operating mode of the wireless power transmitter can include requesting the low power mode profile responsive to a high temperature condition of the wireless power transmitter. Sending a message to the wireless power receiver requesting the power profile corresponding to the operating mode of the wireless power transmitter can include requesting a temporary interruption of wireless power transfer to allow the wireless power transmitter to change an input voltage of the wireless power transmitter.

A method, performed by a wireless power receiver, can include sending a message to a wireless power transmitter selecting a power profile corresponding to an operating mode of the wireless power transmitter and receiving a message from the wireless power transmitter confirming the power profile. The power profile can be selected from the group consisting of a gain measurement mode profile, a low power mode profile, and a nominal mode profile.

The method can further include, prior to sending the message to the wireless power transmitter selecting the power profile corresponding to the operating mode of the wireless power transmitter, receiving a message from the wireless power transmitter requesting the power profile corresponding to the operating mode of the wireless power transmitter. Sending a message to the wireless power transmitter selecting the power profile corresponding to the operating mode of the wireless power transmitter can include selecting the low power mode profile responsive to a high state of charge of a battery of the wireless power receiver. Sending a message to the wireless power transmitter selecting the power profile corresponding to the operating mode of the wireless power transmitter can include selecting the nominal mode profile responsive to a low state of charge of a battery of the wireless power receiver.

### BRIEF DESCRIPTION OF THE DRAWINGS

FIG. 1 illustrates a block diagram of a wireless power transfer system.

FIGS. 2A-2B illustrate a physical configuration of a wireless power transfer system.

FIG. 3 illustrates various combinations of profile aware and not profile aware PTx and PRx devices.

FIG. 4 illustrates an exemplary ASK Profile Select packet.

FIG. 5 illustrates an exemplary FSK Profile Select packet.

FIG. 6 illustrates an exemplary ASK Active Profile packet.

FIG. 7 illustrates an exemplary FSK Active Profile packet.

FIG. 8 depicts a messaging sequence diagram illustrating communication between a wireless power receiver and a wireless power transmitter including various profile exchange messages.

FIG. 9 illustrates a further messaging sequence diagram.

FIG. 10 depicts the message exchanges of FIGS. 8 and 9 with the various exchanges represented as blocks.

FIG. 11A illustrates a further messaging sequence diagram.

FIG. 11B illustrates a further messaging sequence diagram.

FIG. 12 illustrates in block form messaging associated with a profile capable PTx and PRx charging a PRx device starting from a low state of charge in a battery associated with the PRx.

FIG. 13 illustrates in block form messaging associated with a profile capable PTx and PRx charging a PRx device starting from a high state of charge in a battery associated with the PRx.

FIG. 14 illustrates in block form messaging associated with a profile capable PTx and PRx charging a PRx device with a high state of charge, followed by removal of the PRx device and replacement of the PRx device.

FIG. 15 illustrates in block form messaging associated with a profile capable PTx and PRx charging a PRx device with a high state of charge, followed by removal of the PRx device and replacement of the PRx device.

FIG. 16 illustrates in block form messaging associated with a profile capable PTx and PRx charging a PRx device with a low state of charge, followed by removal of the PRx device and replacement of the PRx device.

FIG. 17 illustrates in block form messaging associated with a profile capable PTx and PRx charging a PRx device with a high state of charge, followed by removal of the PRx device and replacement of the PRx device with a device having a high state of charge.

FIG. 18 illustrates in block form messaging associated with a profile capable PTx and PRx charging a PRx device with a high state of charge, followed by removal of the PRx device and replacement of the PRx device with a non-profile aware device.

FIG. 19 illustrates in block form messaging associated with a profile capable PTx and PRx charging a PRx device with a high state of charge, followed by removal of the PRx device and replacement of the PRx device with a non-profile aware device that does not support high frequency operation.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth in order to provide a thorough understanding of the implementations described herein. In other instances, methods, procedures and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

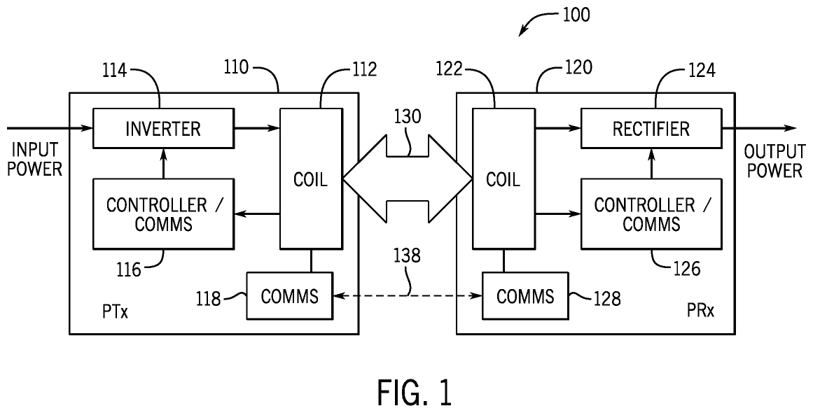

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the PRx, the transmitter coil block 112 illustrated in FIG. 1 may include tuning circuitry, such as additional inductors and capacitors, that facilitate operation of the PTx in different conditions, such as different degrees of magnetic coupling to the PRx, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. In still other embodiments, the wireless coil may be a flat wound coil or an air coil. Other arrangements are also possible and may be used in conjunction with the various embodiments described herein. The wireless transmitter coil may also include a core of magnetically permeable material (e.g., ferrite) dimensioned and positioned to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information, and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation based communications from the PRx. In either case, the controller/communications module 126 may be configured to vary the impedance of the PRx to manipulate the waveform seen on the Tx coil to deliver information to from the PRx to the PTx. For out-of-band communication, additional modules that allow for communication between the PTx and PRx may be provided, for example, WiFi, Bluetooth, infrared (IR) or other radio/light links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications module 118. In some embodiments, comms module 118 may communicate with a corresponding module tag in the PRx via the power transfer coils. In other embodiments, comms module 118 may communicate with a corresponding module using a separate physical channel 138.

As noted above, wireless power transfer system also includes a wireless power receiver (PRx) 120. Wireless power receiver can include a receiver coil 122 that may be magnetically coupled 130 to the transmitter coil 112. As with transmitter coil 112 discussed above, receiver coil block 122 illustrated in FIG. 1 may include tuning circuitry, such as additional inductors and capacitors, that facilitate operation of the PTx in different conditions, such as different degrees of magnetic coupling to the PRx, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the PRx. This information may be received sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation based communications from the PRx. In either case, the controller/communications module 126 may be configured to vary the current drawn by the PRx to manipulate the waveform seen on the Tx coil to deliver information to from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PRx device 120 may optionally include other systems and components, such as a communications (“comms”) module 128. In some embodiments, comms module 128 may communicate with a corresponding module in the PTx via the power transfer coils. In other embodiments, comms module 128 may communicate with a corresponding module or tag using a separate physical channel 138.

Numerous variations and enhancements of the above described wireless power transmission system 100 are possible, and the following teachings are applicable to any of such variations and enhancements.

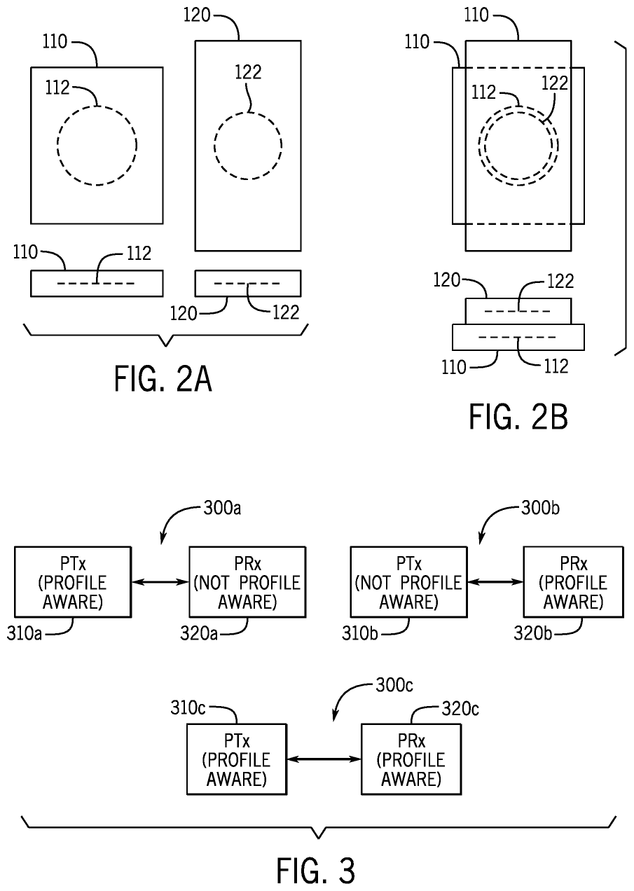

Wireless power transfer as described above depends on the degree of electromagnetic coupling between the PTx and the PRx. For example, in inductive charging systems, the transmitter coil 112 and the receiver coil 122 may be thought of as a loosely-coupled transformer. As such, the relative position of the PTx and PRx can affect the degree of magnetic coupling between the PTx and PRx, which, in turn, can affect the power transfer capability of the system. FIG. 2A illustrates a simplified diagram of a PTx (110)-PRx (120) system. Both devices are illustrated in plan view (upper part of the diagram) and an edge-on section view (lower part of the diagram). PTx device 110 includes transmitter coil 112, and PRx device 120 includes a receiver coil 122. In some embodiments, PTx device 110 may be a wireless charging pad, mat, or stand (or other wireless power transfer device), and PRx device 120 may be a mobile phone, tablet computer, smart watch, (or other wireless power receiver device). Although the respective devices are depicted as generally rectangular in shape with generally circular charging coils, it is to be appreciated that other configurations are also possible.

FIG. 2B illustrates the PTx 110 and PRx 120 in a power transfer position. In FIG. 2B, the devices are horizontally aligned (as depicted in the plan view) and vertically aligned and as close as possible (as illustrated in the sectional view). In this context, horizontal and vertical are merely used as terms of convenience, and the true orientation of the system may vary, and the following description is applicable to a system in any such orientation, although “horizontal” and “vertical” will continue to be used for contextual clarity.

As a practical matter, PTx and PRx devices operate with some degree of independence, even though they must also interoperate. To that end, various “standardized” modes of operation may be defined with each device having one or more operating modes. In some cases, these modes may be part of an industry standard, allowing devices from any manufacturer to operate with devices from any other manufacturer. In other cases, devices from a single manufacturer (or a single manufacturer and its partners) may operate according to a non-public (i.e., proprietary) standard that allows interoperation only between devices from that manufacturer (and its partners). In some cases, devices may be capable of operating according to both a published industry standard (or multiple published industry standards) and a proprietary standard (or multiple proprietary standards). In any case, heretofore, each device may have made certain inferences about the current state of its counterpart device, based on things like timing, packet counting, transmitted power level. However, it would be desirable to define a mechanism by which PTx and PRx devices can explicitly specify their current operating mode/state to a counterpart device. Disclosed below are various mechanisms allowing for such an exchange. More specifically, the following defines various profiles (corresponding to operating modes or states) and messaging protocols for exchanging such profile information.

As noted above, it may be desirable for wireless power transfer devices to interoperate with other wireless power transfer devices that operate according to a different standard, whether public or proprietary. To that end, it is anticipated that, in some cases, a device incorporating the profile communication techniques described herein may interoperate with a corresponding device that is not so capable. For example, in FIG. 3 view 300a, a PTx 310a that is profile aware (i.e., configured to establish and communicate power profiles as described herein) may interoperate with a PRx 320a that is not profile aware. Alternatively, in FIG. 3 view 300b, a PTx 310b that is not profile aware may interoperate with a PRx 320b that is profile aware. Finally, in FIG. 3 view 300c, the PTx 310c and PRx 320c may both be profile aware. Thus, profile aware devices may be configured to exchange profile information with a counterpart device in a way that allows for improved operation by way of counterpart device state awareness when both devices are profile aware, but otherwise does not interfere with interoperation according to an alternative non-profile aware standard/mode of operation if the counterpart device is not profile aware.

To facilitate profile aware interoperation of wireless power transfer devices, various logical profiles may be defined. For example, the profiles can include a gain measurement profile, a nominal power transfer profile, and a light load power transfer profile. Additional profiles may also be defined. These profiles may correspond to various operating states of a wireless power transfer device, including states that exist in present wireless power transfer systems and standards or new states that may be applicable only to certain devices. A gain measurement profile may correspond to a state in which the interoperating wireless power transfer devices are performing “calibration” measurements to determine the degree of coupling between the devices, the maximum or negotiated amount of power transfer that such coupling can support, etc. A Nominal profile may correspond to a state in which power is transferred at a relatively higher rate, e.g., a power rating of either device or a maximum power level that can be supported by the degree of coupling between the devices. A light load profile can correspond to a state in which only a small amount of power is being transferred, e.g., because the capabilities of the respective devices are not known/determined, or because only a small amount of power transfer is required, such as because a battery of a PRx device is nearing a full charge state. In any case, behaviors for both PTx and PRx devices can be defined for each of the profiles/states.

To further facilitate profile aware interoperation of wireless power transfer devices, a messaging protocol can be defined to allow the respective devices to communicate their mode/state to each other and/or to request that the counterpart device switch to a different state. For example messages to request or activate a certain profile, inquire as to a device's active profile, respond to the aforementioned messages, or momentarily pause power transfer may be defined. Illustrative examples of such messages and their usage are discussed in greater detail below. In may be preferable that such messages be incorporated into a standard, such as a public industry standard, to allow devices to take advantage of these enhancements.

When communication is initially established the devices might be operating with different active profiles corresponding to the respective devices' current state. For example, a PRx device may start in either a gain measurement state/profile or a light load profile until it determines whether higher power levels can be delivered. Similarly, a PTx device may start in a light load profile and wait to transition to a higher power level (such as a nominal power level state) until the PRx makes a corresponding request. Thus, it may be desirable for devices to assume that the startup profile of the counterpart device is unknown. It may be preferable for the PRx device to set the initial profile needed. For example, the PRx device may select between a light load or nominal profile/state based on the stage of charge of an on-board battery. Likewise, some devices may be capable of operating at different frequencies, and the PRx may determine the most suitable operating frequency. In such cases, communication may begin at a first “more common” frequency and then transition to a second “more optimal” frequency if both devices are so capable. In such cases, the profile communication and selection may take place at either the first frequency or the second frequency, although it must take place at one or the other. In some embodiments, the negotiation may take place at the first frequency and/or must take place at the second frequency. By optionally conducting the profile exchange at the initial frequency, any reconfiguration or optimization needed for the requested mode can be accomplished during the frequency transition.

Additionally, a request or confirmation of a selected profile may be required at the beginning of a power transfer phase. By requiring a request/confirmation of the selected profile upon entering the power transfer phase, spurious operation due to a device swap can be avoided. Likewise, during power transfer, a device may request switching to a different power profile. For example, a PRx device may request a transition to a light load profile as a battery it is charging approaches a high state of charge. Either a PRx or PTx device may request a transition to a light load profile if necessary for thermal management or other reasons. Numerous other operational scenarios may indicate the desirability of a profile change, thus either device may request a profile change at any time during power transfer.

As noted above, the power profiles may correspond to operating modes or states of the device. Thus, the power transfer capability of a PTx device may change depending on the profile/mode. For example, in the light load mode, a PTx may limit its power transfer to a lower level than it would nominally be capable. As described in greater detail below, this can include reconfiguring an input power source to provide a different input voltage, etc. Additionally, when a profile change is requested, the counterpart device (whether PTx or PRx) may not be ready to perform the change immediately, and therefore a postponement may be requested by the counterpart device. For example, a PTx may need to reconfigure its input voltage when transitioning to or from a light load profile. This may require that the PTx temporarily stop power transfer, an operating mode sometimes known as “cloaking.” Thus, the power profile messaging scheme may include messaging relating to cloaking to facilitate these (or other) mode changes that may not be immediately possible.

As discussed above with respect to FIG. 3, interoperability between profile aware and non-profile aware devices may be desirable. In some cases, PTx and PRx devices may always start in a predefined mode defined by an industry standard. For example, both PTx and PRx devices may start in a gain measurement mode to allow for calibration as described above. Profile aware devices should be designed (i.e., configured or programmed) to operate in a backward compatible mode when they are engaged with a non-profile aware device. During the initiation phases, the devices can determine whether the counterpart device is profile aware using a predefined exchange of messages and analyzing the received responses. In general, this will require the profile aware device to operate according to a non-profile aware mode (e.g., a mode defined by an industry standard) if the corresponding device is not profile aware.

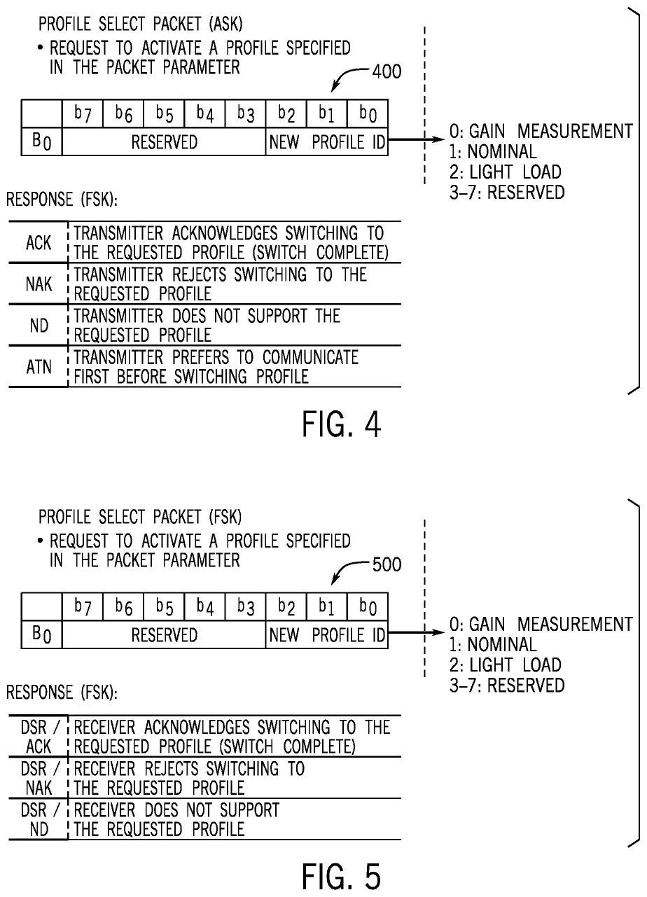

FIG. 4 illustrates an exemplary profile selection packet 400 that a PRx might send to a PTx. Other packet configurations may be used, for example as specified by an appropriate based on an industry standard. This profile selection packet may be sent by in-band or out-of-band communications, as described above with respect to FIG. 1. In the case of in-band communications, the packet may be sent by ASK (amplitude shift keying) if sent by a PRx. In some wireless power transfer applications, PRx devices use some form of ASK/AM (amplitude modulation) to communicate, which they can achieve by selective control of the rectifier switching devices. Conversely, wireless power transmitters can use some form of FSK/FM (frequency shift keying/frequency modulation), which they can achieve by selective control of the inverter switching devices. In any case, one form of a profile select packet can be a byte (B₀) made up of eight bits (b₀-b₇). The upper 5 bits may be reserved, while the lower three bits may indicate the state that the PRx is requesting, with values of 000 corresponding to a gain measurement mode, 001 corresponding to a nominal mode, and 010 corresponding to a light load mode, with the remaining values 011-111 reserved for other modes/states that may be provided in a given application.

Also depicted in FIG. 4 are various replies that a PTx device may send in response to the PRx's profile selection packet. The response may be an ACK (acknowledged), in which the PTx acknowledges switching to the requested profile. The response may be an NAK (not acknowledged), meaning that the PTx is rejecting the requested profile change. The response may be an ND (not defined), indicating that the PTx does not support or understand the selected profile. The response may also be an ATN (attention), indicating that the PTx wishes to communicate before switching profiles. Additionally, the PTx can acknowledge (ACK) the request if the requested state corresponds to the current state (e.g., for state confirmation). These response messages may be defined according to any standard communication protocol employed by the PRx and PTx devices.

FIG. 5 illustrates an exemplary profile selection packet 500 that a PTx might send to a PRx. Other packet configurations may be used, for example as specified by an appropriate industry standard. This profile selection packet may be sent by in-band or out-of-band communications, as described above with respect to FIG. 1. In the case of in-band communications, the packet may be sent by FSK (frequency shift keying) if sent by a PTx. One form of a PTx-sent profile select packet can be a byte (B₀) made up of eight bits (b₀-b₇). The upper 5 bits may be reserved, while the lower three bits may indicate the state that the PRx is requesting, with values of 000 corresponding to a gain measurement mode, 001 corresponding to a nominal mode, and 010 corresponding to a light load mode, with the remaining values 011-111 reserved for other modes/states that may be provided in a given application. In some applications, the PTx-sourced profile select packet may be allowed only in the power transfer phase, for example to allow the PTx to request a transition from a nominal power transfer state to a light load state to avoid overheating. (Other reasons a PTx may request a profile change are also contemplated.)

Also depicted in FIG. 5 are various replies that a PRx device may send in response to the PTx's profile selection packet. The response may be an ACK (acknowledged), in which the PRx acknowledges switching to the requested profile. The response may be an NAK (not acknowledged), meaning that the PRx is rejecting the requested profile change. The response may be an ND (not defined), indicating that the PRx does not support or understand the selected profile. As noted above, the PRx can acknowledge (ACK) the request if the requested state corresponds to the current state (e.g., for state confirmation). These response messages may be defined according to any standard communication protocol employed by the PRx and PTx devices.

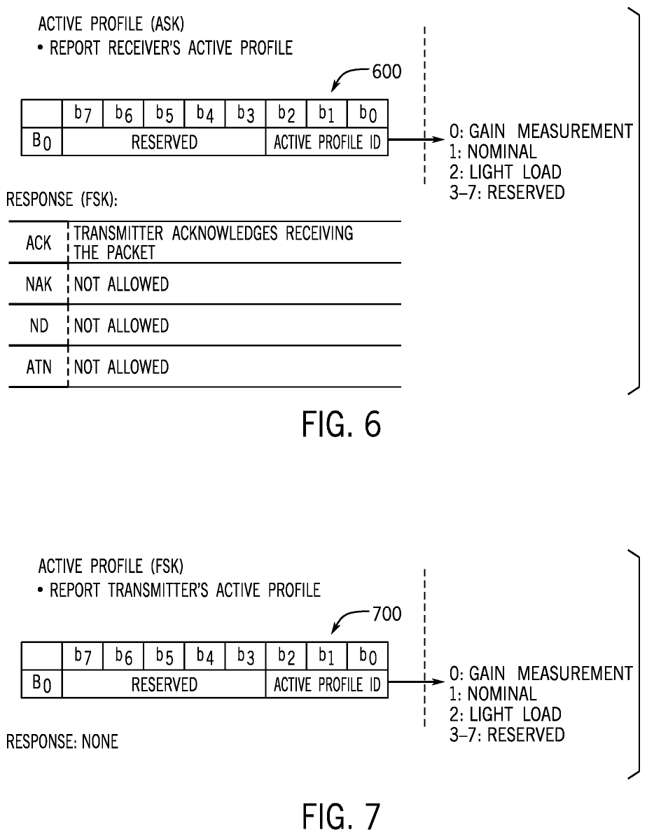

FIG. 6 illustrates an active profile packet 600 that a PRx might send to a PTx in response to a request from the PTx for the PRx's active state. Other packet configurations may be used, for example as specified by an appropriate industry standard. This active profile packet may be sent by in-band or out-of-band communications, as described above with respect to FIG. 1. In the case of in-band communications, the packet may be sent by ASK (amplitude shift keying) if sent by a PRx. In any case, one form of an active profile packet can be a byte (B₀) made up of eight bits (b₀-b₇). The upper 5 bits may be reserved, while the lower three bits may indicate the state of the PRx, with values of 000 corresponding to a gain measurement mode, 001 corresponding to a nominal mode, and 010 corresponding to a light load mode, with the remaining values 011-111 reserved for other modes/states that may be provided in a given application.

Also depicted in FIG. 6 is the expected that a PTx device may send in response to the PRx's profile selection packet, which may be limited to an ACK (acknowledged), in which the PTx acknowledges the PRx's profile. The response message may be defined according to any standard communication protocol employed by the PRx and PTx devices.

FIG. 7 illustrates an active profile packet 700 that a PTx might send to a PRx in response to a request from the PRx for the PTx's active state. Other packet configurations may be used, for example as specified by an appropriate industry standard. This active profile packet may be sent by in-band or out-of-band communications, as described above with respect to FIG. 1. In the case of in-band communications, the packet may be sent by FSK (frequency shift keying) if sent by a PTx. In any case, one form of an active profile packet can be a byte (B₀) made up of eight bits (b₀-b₇). The upper 5 bits may be reserved, while the lower three bits may indicate the state of the PTx, with values of 000 corresponding to a gain measurement mode, 001 corresponding to a nominal mode, and 010 corresponding to a light load mode, with the remaining values 011-111 reserved for other modes/states that may be provided in a given application. No response need be sent/defined for this packet type.

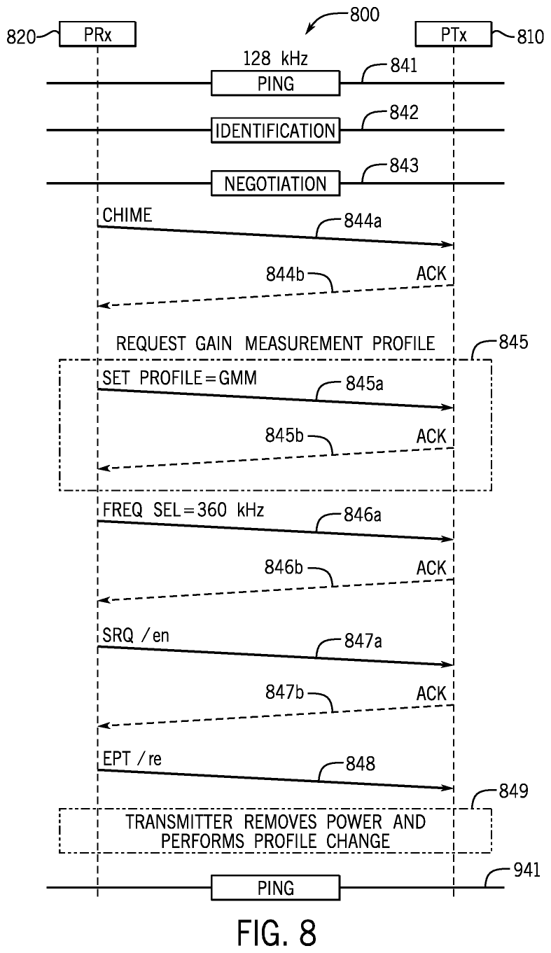

FIG. 8 depicts a messaging sequence diagram 800 illustrating communication between a wireless power receiver (PRx 820) and a wireless power transmitter (PTx 810) including various profile exchange messages as described above. More specifically, messaging sequence diagram 800 can be a startup sequence in which the PRx 820 requests that PTx 810 enter the gain management mode prior to requesting a change to a different operating frequency. Beginning with 841, a sequence of ping messages may be exchanged in accordance with an industry standard protocol, such as the Qi protocol for wireless power transfer, as promulgated by the Wireless Power Consortium. Following this, a sequence of messages 842 may be exchanged in which the PTx and/or PRx identify themselves to one another. Then, a negotiation 843 to establish a suitable power transfer channel may proceed (with these messages illustrated in former detail). Message 844a may be sent from the PRx to the PTx indicating that a chime notifying the user that the PTx and PRx have established communications. The PTx may acknowledge this message with ACK message 844b. At 845a, Rx 820 may send a message 845a asking the PTx to establish the gain measurement profile. Message 845a may have the form indicated above or may take any other suitable form. PTx 810 may acknowledge (and confirm entry into the gain management mode) by sending ACK message 845b. This exchange 845 may, in some cases be optional. Then, optionally, in message 846a PRx 820 may request a frequency change to another frequency (e.g., 360 kHz—with the prior communication have taken place at 128 kHz)), which may also be acknowledge (846b) by PTx 810. Further messages 847a and 848 may be sent by PRx 820 to effectuate the frequency change, with message 847a being acknowledged by PTx 810 and PTx 810 subsequently depowering to perform the profile change, resulting in a new ping at 941.

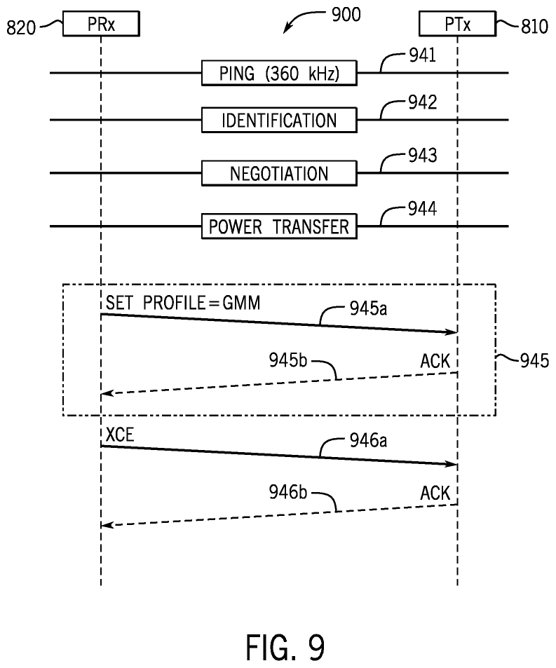

FIG. 9 illustrates a further messaging sequence diagram 900 that picks up where the diagram of FIG. 8 left off, i.e., with message sequence 941 corresponding to a ping at the new operating frequency. Messaging sequence 900 can be a continuation of the above described sequence following a requested frequency change. Corresponding identification message exchanges 942 and negotiation message exchanges 943 may then take place similar to those described above, but at the new operating frequency. Then, upon entering the power transfer state 944, PRx 820 may send a set profile message 945a confirming the instruction for PTx 810 to transition to the gain measurement mode. PTx 810 may send ACK message 945b acknowledging this instruction. Further communication 946a (XCE) and 946b (ACK) may proceed with power transfer. As described above, exchange 945, confirming the profile instruction from PRx 820 to PTx 810 may be mandatory for some embodiments.

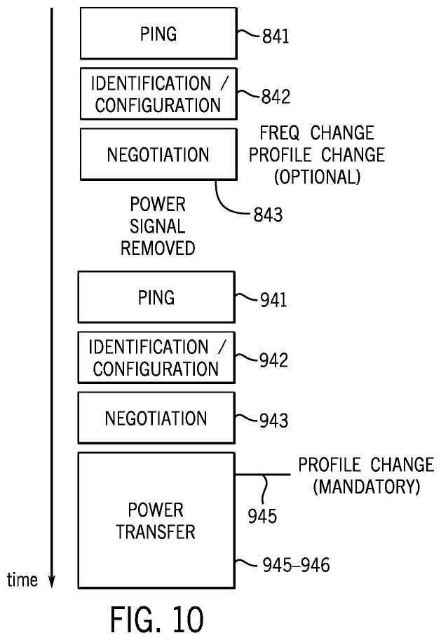

FIG. 10 is a diagram depicting the exchange of FIGS. 8 and 9 as described above with the various exchanges represented as blocks using identical reference numbers. As noted with respect to block 843, the frequency change profile change may be optional, while the profile confirmation 945 may be mandatory.

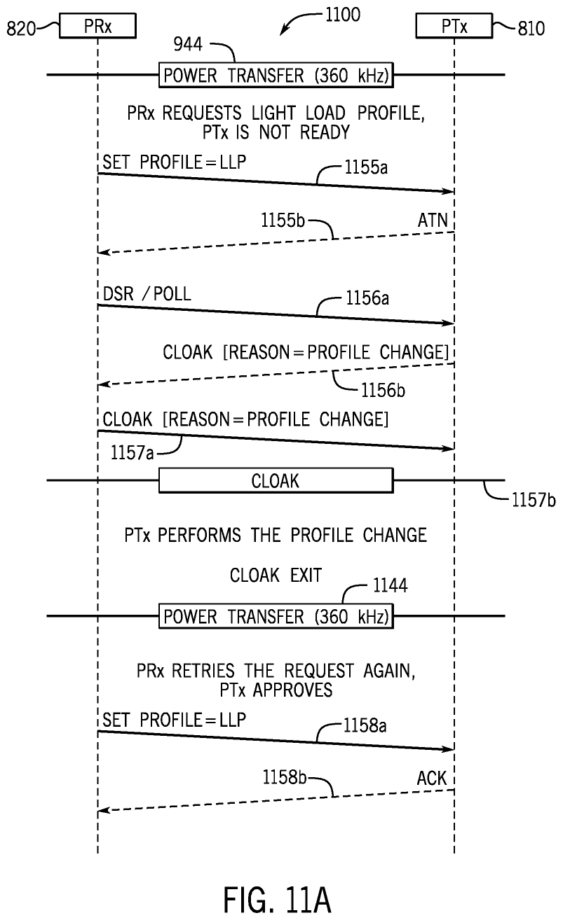

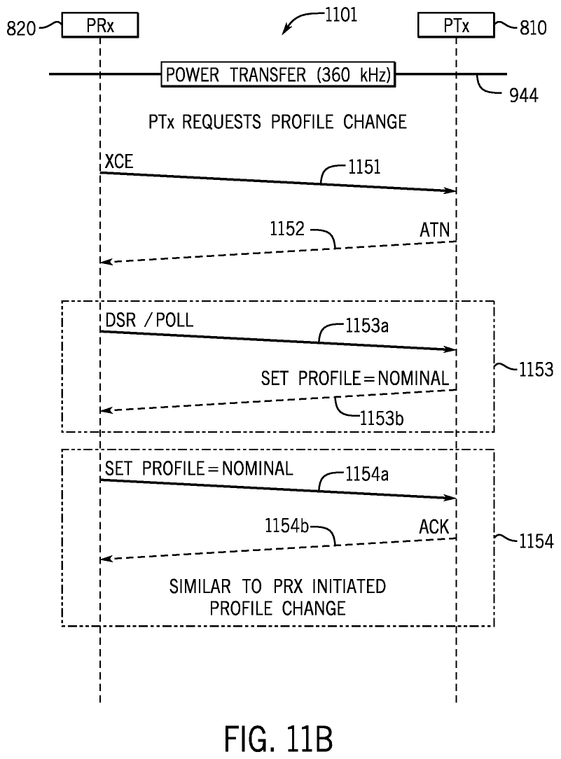

FIG. 11A illustrates a further messaging sequence diagram 1100 that may follow the exchanges described above with respect to FIGS. 8-10. Messaging sequence diagram 1100 can correspond to a request by the PRx 820 to transition to a light load profile, e.g., when a battery being charged by PRx 820 approaches a full state of charge. While in the power transfer state (944), PRx may send message 1155a requesting that PTx transition to the light load profile. PTx 810 may respond with an ATN (attention) message 1155b, indicating that PTx 810 wants to defer the profile change. In response, PRx 820 can send a poll message 1156a, to which PTx 810 may respond with a Cloak[Reason=Profile Change] message 1156b. This message can convey to the PRx that, to comply with the request from PRx, PTx will need to momentarily interrupt power transfer. As one example, this may be because the PTx is powered by a USB-PD device, and wants to change the input operating voltage due to the requested lower power transfer level. PRx 820 may respond with Cloak message 1157a, confirming/instructing the PTx transfer to the cloaked state 1157b, which PTx may enter. Upon resuming the power transfer mode 1144 following the cloak, PRx 820 may send a second/confirming set profile message 1158a instructing the PTx to enter the low power profile, which PTx 810 can confirm with ACK message 1158b.

FIG. 11B illustrates a further messaging sequence diagram 1101 that may follow the exchanges described above with respect to FIGS. 8-10. Messaging sequence diagram 1101 can correspond to request by PTx 810 to enter a nominal power transfer state. While in the power transfer state (944), as part of normal power transfer PRx may send XCE message 1151, with PTx 810 responding with an ATN (attention) message 1152, effectively notifying PRx 820 that PTx 810 wishes to talk. In response, PRx may respond with polling message 1153a, to which PTx 810 may reply with message 1153b, requesting that the profile be set to the nominal profile. PRx 820 may then send a set profile to nominal message 1153a, to which PTx 810 can respond with an ACK message 1154b confirming the transition to the nominal power profile.

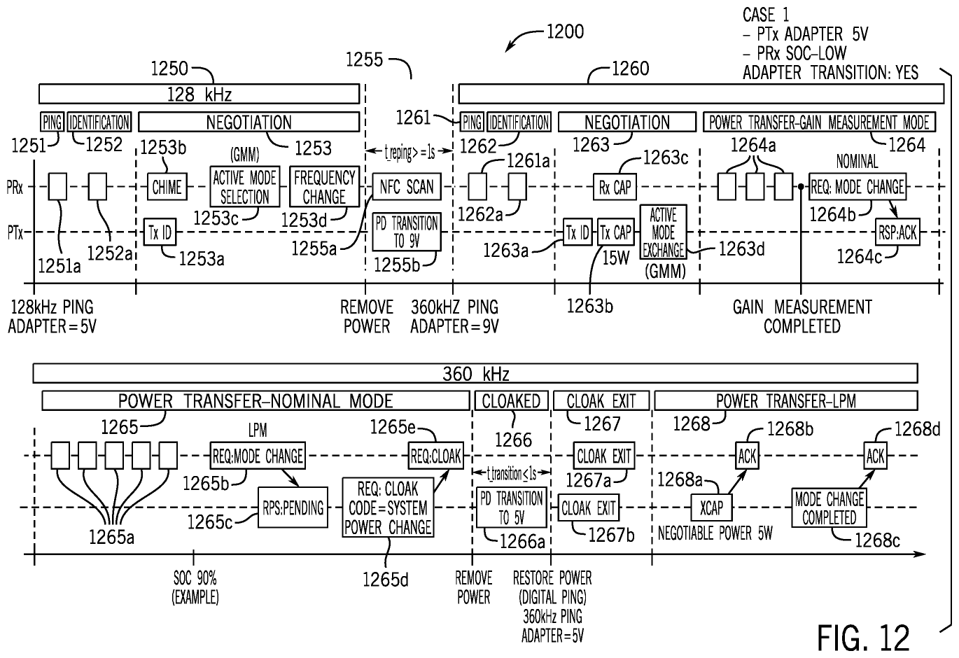

The foregoing diagrams include examples of various exchanges using the power profile mechanism described above; however, these examples are not exhaustive. Other mode transition requests in different sequences may take place depending on the particular system, operating state, etc. FIG. 12-19, discussed below, illustrate (in block form similar to FIG. 10) exemplary exchanges for profile transition in different usage scenarios. As above, these are not exhaustive, and are provided merely to illustrate some of the ways in which the power profiles and associated messaging profiles may be employed in a wireless power transfer system.

FIG. 12 illustrates in block form messaging associated with a profile capable PTx and PRx charging a PRx device starting from a low state of charge in a battery associated with the PRx. The entire time sequence can be divided into a low frequency phase 1250 and a high frequency phase 1260. (However, a frequency change is not required, and, in some applications, the entire operation could be conducted at a single operating frequency). The low frequency phase 1250 can be divided into a ping phase 1251 (with associated messaging 1251a), an identification phase 1252 (with associated messaging 1252a), and a negotiation phase 1253 with messaging 1253a-1253d. These messages can include the PTx identifying itself (1253a), and the PRx sending a chime message 1253b, a mode selection message 1253c (selecting the gain measurement mode, as described above), and a frequency transition message 1253d. Then, the PTx device can remove power, initiating intermediate phase 1255, during which the PRx can optionally conduct a scan 1255a for NFC (near field communication devices) and the PTx can transition its input power adapter to a higher voltage for operation at the higher frequency (optionally also at a higher power level).

This begins high frequency phase 1260, which can be divided into ping phase 1261 (with associated messaging 1261a), an identification phase 1262 (with associated messaging 1262a), and a negotiation phase 1263 with messaging 1263a-1263d. These messages can include the PTx identifying itself (1263a) and sending its capabilities 1263b (for example, indicating the ability to charge at a higher power level). Likewise, the PRx can send its capabilities via message 1263c. Then, PTx can send message 1263d confirming entry into the requested gain management mode. In gain management phase 1264, a plurality of PRx messages 1264a may be sent allowing the PTx to compute the gain. After this, the PRx can send a mode change request message 1264b (e.g., requesting a transition to the nominal power transfer mode as described above), which the PTx can acknowledge (1264c). This begins the nominal power transfer mode 1264, which can include a plurality of feedback packets 1265a from PRx to PTx. As the PRx battery approaches full charge (e.g., at a 90% state of charge), the PRx can send a mode change request message 1265b, for example requesting a transition to the light load/low power state. The PTx can reply with an ATN or similar message 1265c with a follow on message (1265d) requesting a cloak to transition the input voltage source back to a lower voltage. The PRx can then respond with a cloak request. This begins the cloaked state 1266, during which time the PTx can again transition the input power adapter (1266a). In the cloak exit phase 1267, The PTx and PRx may send respective messages 1267b and 1267a) confirming the cloak exit. Then in the light load/low power phase 1268, the PTx can send capabilities 1268a to the PRx, which the PRx can acknowledge with message 1268b. Then the PTx can send a mode change completed message 1268c, which can be acknowledged by the PRx with ACK message 1268d.

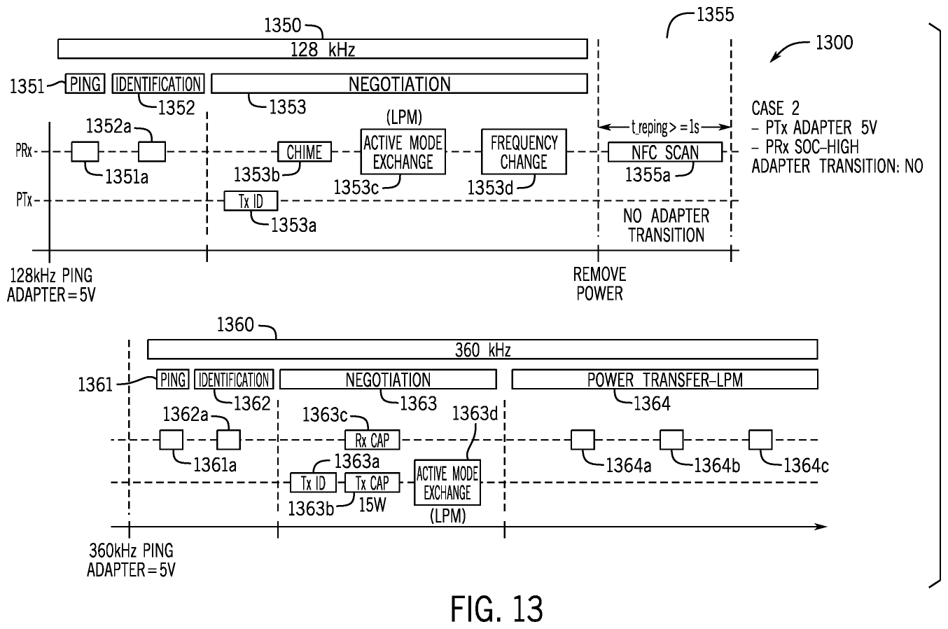

FIG. 13 illustrates in block form messaging associated with a profile capable PTx and PRx charging a PRx device starting from a high state of charge in a battery associated with the PRx. The entire time sequence can be divided into a low frequency phase 1350 and a high frequency phase 1360. (However, a frequency change is not required, and, in some applications, the entire operation could be conducted at a single operating frequency). The low frequency phase 1350 can be divided into a ping phase 1351 (with associated messaging 1351a), an identification phase (with associated messaging 1352a), and a negotiation phase 1353 with messaging 1353a-1353d. These messages can include the PTx identifying itself (1353a), and the PRx sending a chime message 1353b, a mode selection message 1353c (selecting the low power/light load mode, as described above), and a frequency transition message 1353d. Then, the PTx device can remove power, initiating intermediate phase 1355 during which the PRx can conduct a NFC device scan 1355a. However, because there will not be a high power operation (at least at this point), the PTx need not transition its adapter to a higher operating voltage.

This begins high frequency phase 1360, which can be divided into ping phase 1361 (with associated messaging 1361a), an identification phase 1362 (with associated messaging 1362a), and a negotiation phase 1363 with messaging 1363a-1363d. These messages can include the PTx identifying itself (1363a) and sending its capabilities 1363b (for example, indicating the ability to charge at a higher power level). Likewise, the PRx can send its capabilities via message 1363c. Then, PTx can send message 1363d confirming entry into the requested gain management mode. In low power/light load power transfer mode 1364, a plurality of PRx messages 1364a-1364c may be as ordinary feedback for PTx control.

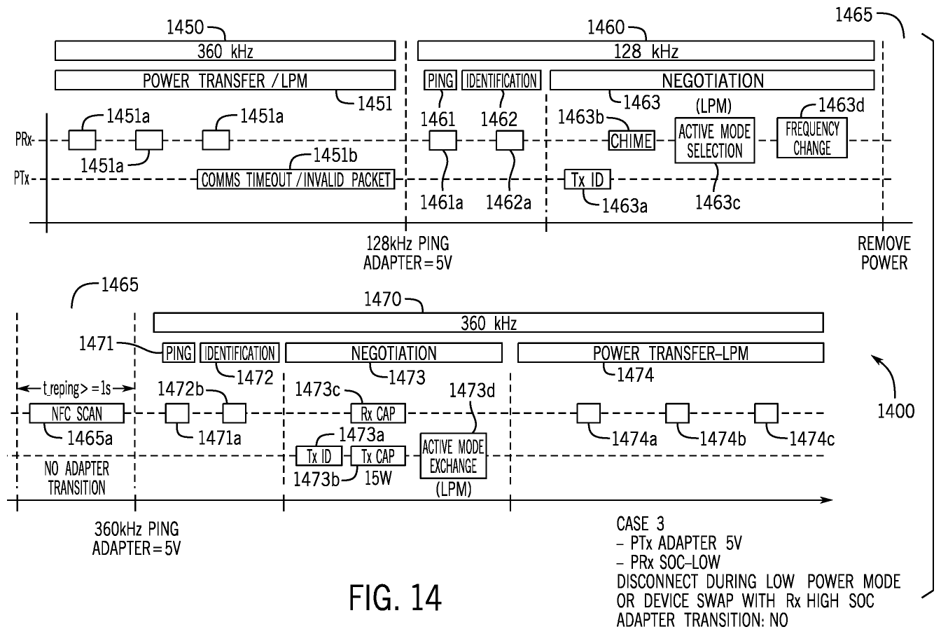

FIG. 14 illustrates in block form messaging associated with a profile capable PTx and PRx charging a PRx device with a high state of charge, followed by removal of the PRx device and replacement of the PRx device. This may occur, for example, if the user picks up a device—such as a mobile phone—and returns it to the charging pad after brief usage. The entire time sequence can be divided into a high frequency phase 1450, a subsequent low frequency phase 1460, and a further high frequency phase 1470. (However, a frequency change is not required, and, in some applications, the entire operation could be conducted at a single operating frequency). The high frequency phase 1450 can include a power transfer mode in the low power/light load mode 1451. This state may follow on to one of the scenarios described above with respect to FIGS. 12 and 13. In this initial high frequency phase 1450, a plurality of feedback packets 1451a may be sent by the PRx, with the PTx ending the power transfer mode at 1451b when either no feedback packet is received or an invalid feedback packet is received (indicating that the PRx device has been removed from the PTx). Then, when a PRx device appears (or reappears as the case may be), a low frequency phase can begin with be divided into a ping phase 1461 (with associated messaging 1461a), an identification phase (with associated messaging 1462a), and a negotiation phase 1463 with messaging 1463a-1463d. These messages can include the PTx identifying itself (1463a), and the PRx sending a chime message 1463b, a mode selection message 1463c (selecting the low power/light load mode, as described above), and a frequency transition message 1463d. Then, the PTx device can remove power, initiating intermediate phase 1465, during which the PRx can optionally conduct a scan 1465a for NFC (near field communication devices). As in the example discussed above with respect to FIG. 13, because the device will be in the low power/light load mode, no input voltage transition on the PTx side is required.

This begins subsequent high frequency phase 1470, which can be divided into ping phase 1471 (with associated messaging 1471a), an identification phase 1472 (with associated messaging 1472a), and a negotiation phase 1473 with messaging 1473a-1473d. These messages can include the PTx identifying itself (1473a) and sending its capabilities 1473b (for example, indicating the ability to charge at a higher power level). Likewise, the PRx can send its capabilities via message 1473c. Then, PTx can send message 1473d confirming entry into the requested low power/light load mode. In low power/light load power transfer mode 1474, a plurality of PRx messages 1474a-1474c may be as ordinary feedback for PTx control.

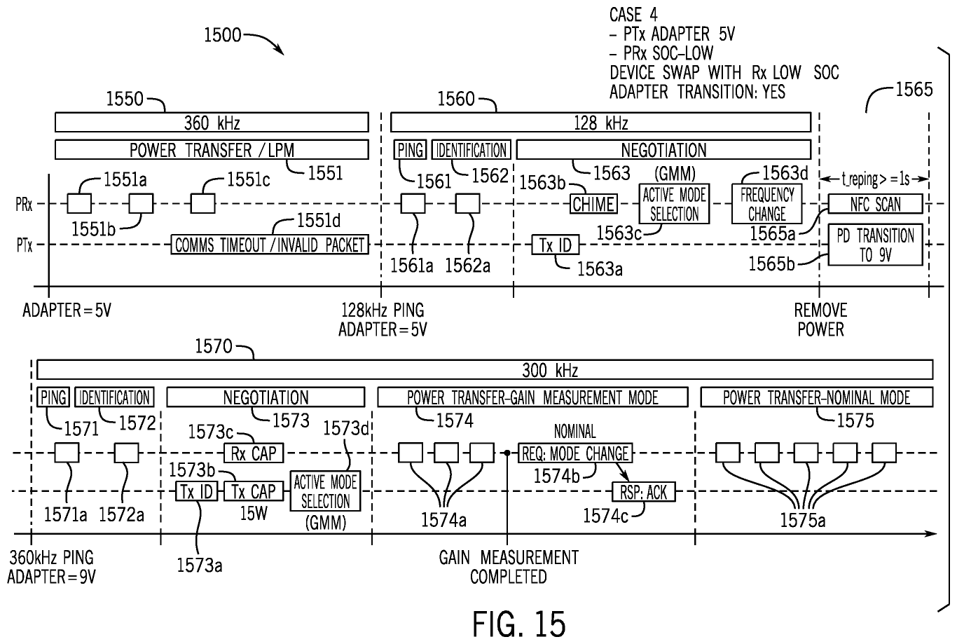

FIG. 15 illustrates in block form messaging associated with a profile capable PTx and PRx charging a PRx device with a high state of charge, followed by removal of the PRx device and replacement of the PRx device. This may occur, for example, if the user picks up a device—such as a mobile phone—and returns it to the charging pad after brief usage. The entire time sequence can be divided into a high frequency phase 1550, a subsequent low frequency phase 1560, and a further high frequency phase 1570. (However, a frequency change is not required, and, in some applications, the entire operation could be conducted at a single operating frequency). The high frequency phase 1550 can include a power transfer mode in the low power/light load mode 1551. This state may follow on to one of the scenarios described above with respect to FIGS. 12 and 13. In this initial high frequency phase 1550, a plurality of feedback packets 1551a-1551c may be sent by the PRx, with the PTx ending the power transfer mode at 1551d when either no feedback packet is received or an invalid feedback packet is received (indicating that the PRx device has been removed from the PTx). Then, when a PRx device appears (or reappears as the case may be), a low frequency phase 1560 can begin with be divided into a ping phase 1561 (with associated messaging 1561a), an identification phase 1562 (with associated messaging 1562a), and a negotiation phase 1563 with messaging 1563a-1563d. These messages can include the PTx identifying itself (1563a), and the PRx sending a chime message 1563b, a mode selection message 1563c (selecting the gain measurement mode, as described above), and a frequency transition message 1563d. Then, the PTx device can remove power, initiating intermediate phase 1565, during which the PRx can optionally conduct a scan 1565a for NFC (near field communication devices). As in the example discussed above with respect to FIG. 12, because the device will be in the nominal (higher power mode) the PTx can cause an input voltage transition.

This begins subsequent high frequency phase 1570, which can be divided into ping phase 1571 (with associated messaging 1571a), an identification phase 1572 (with associated messaging 1572a), and a negotiation phase 1573 with messaging 1573a-1573d. These messages can include the PTx identifying itself (1573a) and sending its capabilities 1573b (for example, indicating the ability to charge at a higher power level). Likewise, the PRx can send its capabilities via message 1573c. Then, PTx can send message 1573d confirming entry into the gain measurement mode. In gain management phase 1574, a plurality of PRx messages 1574a may be sent allowing the PTx to compute the gain. After this, the PRx can send a mode change request message 1574b (e.g., requesting a transition to the nominal power transfer mode as described above), which the PTx can acknowledge (1574c). This begins the nominal power transfer mode 1575, which can include a plurality of feedback packets 1575a from PRx to PTx. As the PRx battery approaches full charge (e.g., at a 90% state of charge), the PRx can send a mode change request message to transition to a low power/light load mode as was described above.

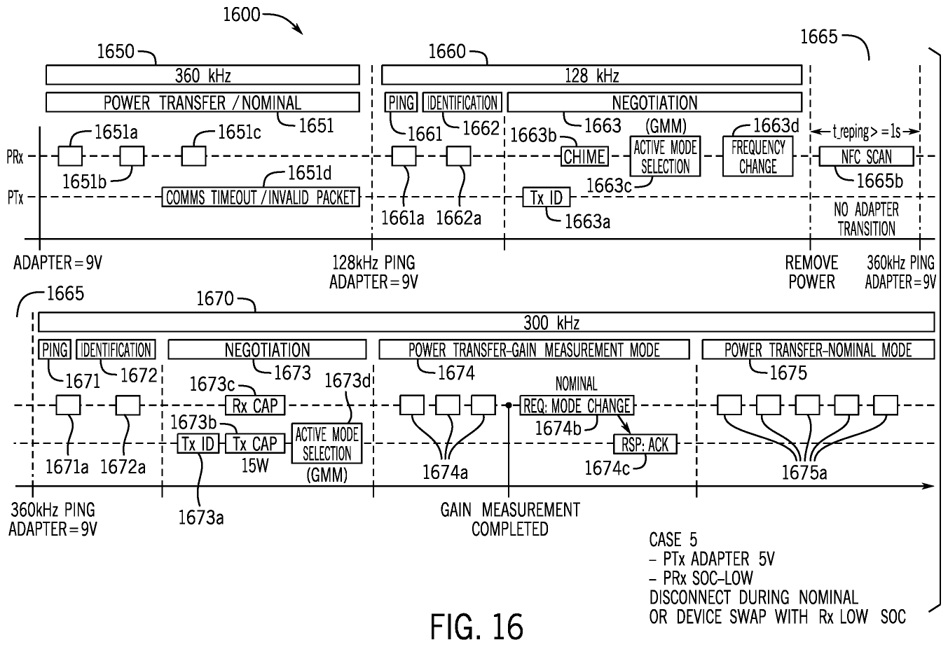

FIG. 16 illustrates in block form messaging associated with a profile capable PTx and PRx charging a PRx device with a low state of charge, followed by removal of the PRx device and replacement of the PRx device. This may occur, for example, if the user picks up a device—such as a mobile phone—and returns it to the charging pad after brief usage. The entire time sequence can be divided into a high frequency phase 1650, a subsequent low frequency phase 1660, and a further high frequency phase 1670. (However, a frequency change is not required, and, in some applications, the entire operation could be conducted at a single operating frequency). The high frequency phase 1650 can include a nominal power transfer mode 1651. This state may follow on to one of the scenarios described above. In this initial high frequency phase 1650, a plurality of feedback packets 1651a-1651c may be sent by the PRx, with the PTx ending the power transfer mode at 1651d when either no feedback packet is received or an invalid feedback packet is received (indicating that the PRx device has been removed from the PTx). Then, when a PRx device appears (or reappears as the case may be), a low frequency phase 1660 can begin with be divided into a ping phase 1661 (with associated messaging 1661a), an identification phase 1662 (with associated messaging 1662a), and a negotiation phase 1663 with messaging 1663a-1663d. These messages can include the PTx identifying itself (1663a), and the PRx sending a chime message 1663b, a mode selection message 1663c (selecting the gain measurement mode, as described above), and a frequency transition message 1663d. Then, the PTx device can remove power, initiating intermediate phase 1665, during which the PRx can optionally conduct a scan 1665a for NFC (near field communication devices). Because the device will remain in the nominal (higher power mode) the PTx need not cloak to transition its input voltage.

This begins subsequent high frequency phase 1670, which can be divided into ping phase 1671 (with associated messaging 1671a), an identification phase 1672 (with associated messaging 1672a), and a negotiation phase 1673 with messaging 1673a-1673d. These messages can include the PTx identifying itself (1673a) and sending its capabilities 1673b (for example, indicating the ability to charge at a higher power level). Likewise, the PRx can send its capabilities via message 1673c. Then, PTx can send message 1673d confirming entry into the gain measurement mode. In gain management phase 1674, a plurality of PRx messages 1674a may be sent allowing the PTx to compute the gain. After this, the PRx can send a mode change request message 1674b (e.g., requesting a transition to the nominal power transfer mode as described above), which the PTx can acknowledge (1674c). This begins the nominal power transfer mode 1675, which can include a plurality of feedback packets 1675a from PRx to PTx. As the PRx battery approaches full charge (e.g., at a 90% state of charge), the PRx can send a mode change request message to transition to a low power/light load mode as was described above.

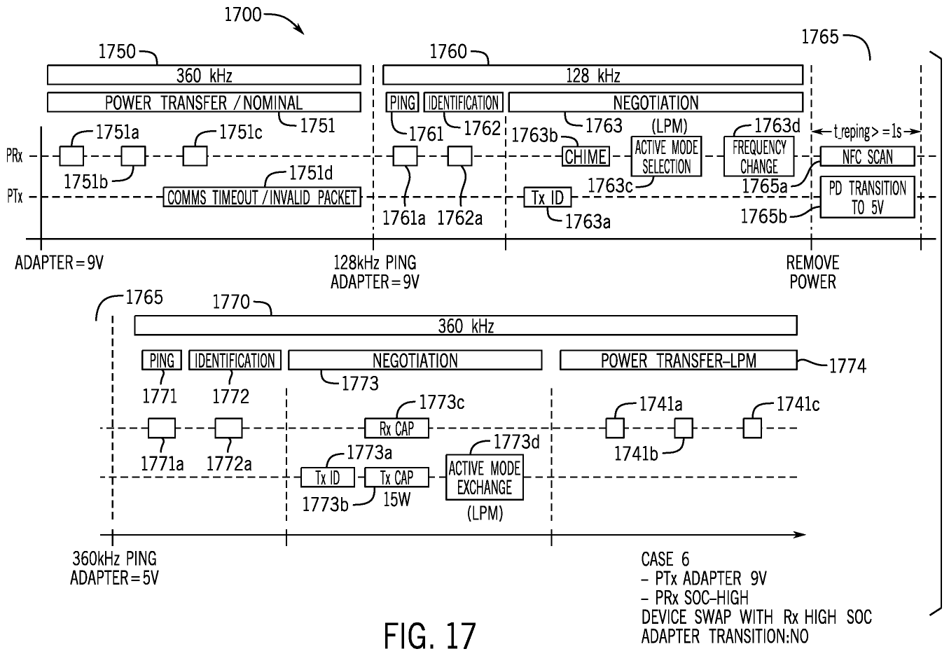

FIG. 17 illustrates in block form messaging associated with a profile capable PTx and PRx charging a PRx device with a low state of charge, followed by removal of the PRx device and replacement of the PRx device with a device having a high state of charge. This may occur, for example, if the user swaps devices. The entire time sequence can be divided into a high frequency phase 1750, a subsequent low frequency phase 1760, and a further high frequency phase 1770. (However, a frequency change is not required, and, in some applications, the entire operation could be conducted at a single operating frequency). The high frequency phase 1750 can include a nominal power transfer mode 1751. This state may follow on to one of the scenarios described above. In this initial high frequency phase 1750, a plurality of feedback packets 1751a-1751c may be sent by the PRx, with the PTx ending the power transfer mode at 1751d when either no feedback packet is received or an invalid feedback packet is received (indicating that the PRx device has been removed from the PTx). Then, when a PRx device appears (or reappears as the case may be), a low frequency phase 1760 can begin with be divided into a ping phase 1761 (with associated messaging 1761a), an identification phase 1762 (with associated messaging 1762a), and a negotiation phase 1763 with messaging 1763a-1763d. These messages can include the PTx identifying itself (1763a), and the PRx sending a chime message 1763b, a mode selection message 1763c (selecting the low power/light load mode, as described above), and a frequency transition message 1763d. Then, the PTx device can remove power, initiating intermediate phase 1765, during which the PRx can optionally conduct a scan 1765a for NFC (near field communication devices). Because the device will transition to the low power/light load mode, the PTx can transition its input adapter to a lower voltage.

This begins high frequency phase 1770, which can be divided into ping phase 1771 (with associated messaging 1771a), an identification phase 1772 (with associated messaging 1772a), and a negotiation phase 1773 with messaging 1773a-1773d. These messages can include the PTx identifying itself (1773a) and sending its capabilities 1773b (for example, indicating the ability to charge at a higher power level). Likewise, the PRx can send its capabilities via message 1773c. Then, PTx can send message 1773d confirming entry into the requested gain management mode. In low power/light load power transfer mode 1774, a plurality of PRx messages 1774a-1774c may be as ordinary feedback for PTx control.

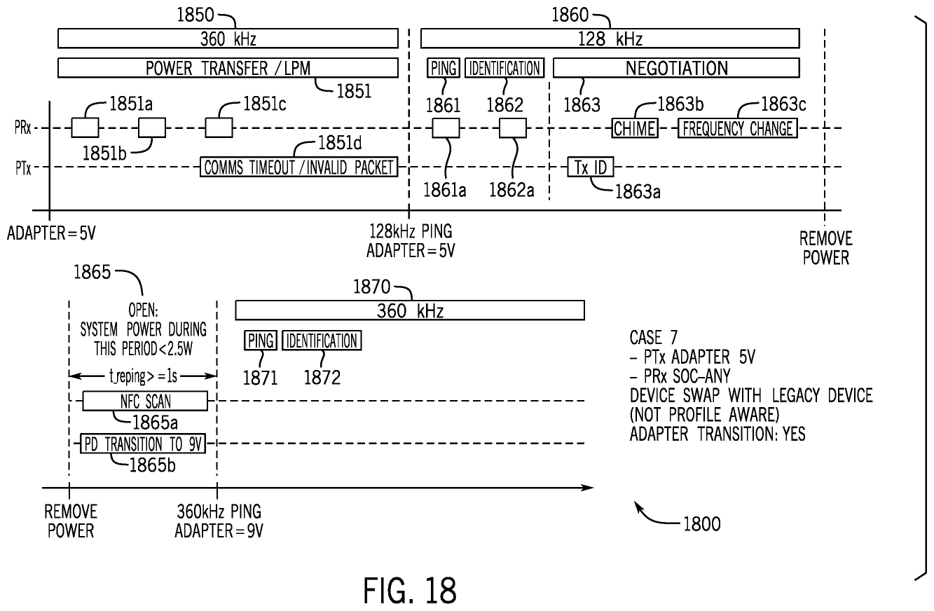

FIG. 18 illustrates in block form messaging associated with a profile capable PTx and PRx charging a PRx device with a high state of charge, followed by removal of the PRx device and replacement of the PRx device with a non-profile aware device. The entire time sequence can be divided into a high frequency phase 1850, a subsequent low frequency phase 1860, and a further high frequency phase 1870. (However, a frequency change is not required, and, in some applications, the entire operation could be conducted at a single operating frequency). The high frequency phase 1850 can include a power transfer mode in the low power/light load mode 1851. This state may follow on to one of the scenarios described above. In this initial high frequency phase 1850, a plurality of feedback packets 1851a-1851c may be sent by the PRx, with the PTx ending the power transfer mode at 1851d when either no feedback packet is received or an invalid feedback packet is received (indicating that the PRx device has been removed from the PTx). Then, when a PRx device appears (this one not being profile aware), a low frequency phase 1860 can begin with be divided into a ping phase 1861 (with associated messaging 1861a), an identification phase 1862 (with associated messaging 1862a), and a negotiation phase 1863 with messaging 1863a-1863c. These messages can include the PTx identifying itself (1863a), and the PRx sending a chime message 1863b, and a frequency transition message 1863c, but no mode selection message, as the new device is profile unaware. Then, the PTx device can remove power, initiating intermediate phase 1865, during which the PRx can optionally conduct a scan 1865a for NFC (near field communication devices). As in various examples discussed above with, because the device will be in the nominal (higher power mode) the PTx can cause an input voltage transition to a higher input voltage.

This begins subsequent high frequency phase 1870, which can be divided into ping phase 1871, and an identification phase 1872, which may be in compliance with a version of a wireless power transfer standard that does not include the profiles, as the new PRx device is not profile aware.

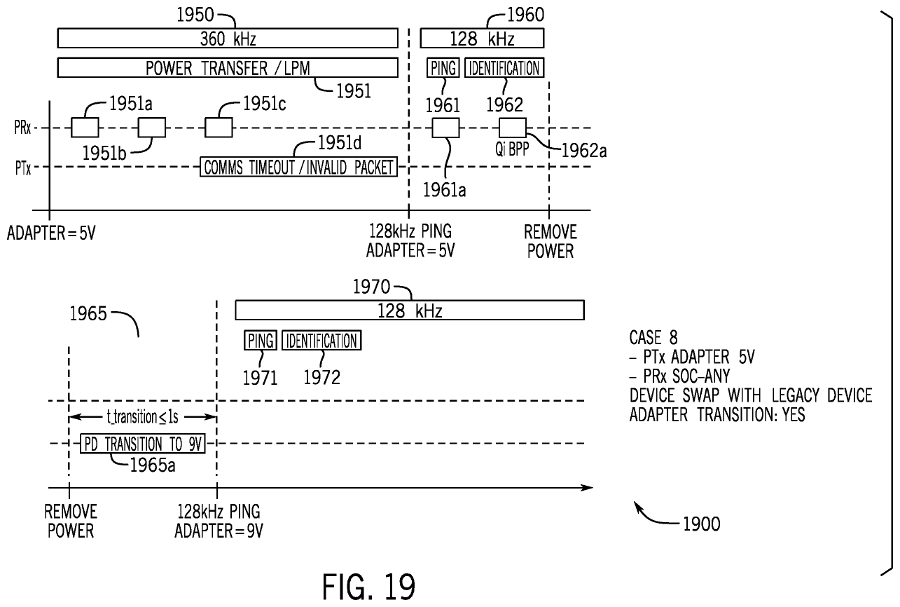

FIG. 19 illustrates in block form messaging associated with a profile capable PTx and PRx charging a PRx device with a high state of charge, followed by removal of the PRx device and replacement of the PRx device with a non-profile aware device that does not support high frequency operation. The entire time sequence can be divided into a high frequency phase 1950, a subsequent low frequency phase 1960, and a further low frequency phase 1970. (However, a frequency change is not required, and, in some applications, the entire operation could be conducted at a single operating frequency). The high frequency phase 1950 can include a power transfer mode in the low power/light load mode 1951. This state may follow on to one of the scenarios described above. In this initial high frequency phase 1950, a plurality of feedback packets 1951a-1951c may be sent by the PRx, with the PTx ending the power transfer mode at 1951d when either no feedback packet is received or an invalid feedback packet is received (indicating that the PRx device has been removed from the PTx). Then, when a PRx device appears (this one not being profile aware), a low frequency phase 1960 can begin with be divided into a ping phase 1961 (with associated messaging 1961a) and an identification phase 1962 (with associated messaging 1962a). Then, the PTx device can remove power, initiating intermediate phase 1965, during which an adapter transition may (but need not) take place. Then, the low frequency operation can resume in low frequency mode 1970 with a further ping and identification phases 1971 and 1972 respectively. In these cases, power transfer may take place according to a baseline power profile, without the enhancements of multi-frequency operation or mode awareness as described herein.

The above described scenarios are merely illustrative examples, and are not intended to be exhaustive of all the ways in which wireless power transfer devices can have and communicate a plurality of different operating modes to counterpart devices. Various permutations, combinations, and extensions of the arrangements described above could also be used as appropriate for a given application, system, and operating condition.

The foregoing describes exemplary embodiments of wireless power transfer systems power profiles for state synchronization between wireless power transmitter (PTx) and wireless power receiver (PRx). Such systems may be used in a variety of applications but may be particularly advantageous when used in conjunction with wireless power transfer systems for personal electronic devices such as mobile computing devices (e.g., laptop computers, tablet computers, smart phones, and the like) and their accessories (e.g., wireless earphones, styluses and other input devices, etc.) as well as wireless charging accessories (e.g., charging mats, pads, stands, etc.). Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information amongst the PTx and PRx in the system. The present disclosure contemplates this passage of information to improve the devices' ability to provide wireless power to each other in an efficient manner to facilitate battery charging, such as by sharing of the devices' power handling capabilities with one another. Entities implementing the present technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system, and allow users to “opt in” or “opt out” of participation. For instance, such information may be presented to the user when they place a device onto a power transmitter, if the power transmitter is configured to poll for sensitive information from the power receiver.

Risk can be minimized by limiting the collection of data and deleting data once it is no longer needed. In addition, and when applicable, data de-identification can be used to protect a user's privacy. For example, a device identifier may be partially masked to convey the power characteristics of the device without uniquely identifying the device. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy. Robust encryption may also be utilized to reduce the likelihood that communication between inductively coupled devices are spoofed.

1. A wireless power transmitter comprising:
a wireless power transfer coil;
an inverter that receives an input DC voltage and outputs an AC voltage to the wireless power transfer coil so as to deliver power to a wireless power receiver; and
a communications module configured to communicate with the wireless power receiver by transmitting and receiving messages requesting, selecting, or confirming one of a plurality of power profiles of the wireless power transmitter, the plurality of power profiles corresponding to a gain measurement mode, a nominal mode that delivers a relatively higher power level, and a light load mode that delivers a relatively lower power level.

2. The wireless power transmitter of claim 1 further configured to set an operating mode of the wireless power transmitter responsive to a message received from the wireless power receiver selecting a power profile corresponding to the operating mode.

3. The wireless power transmitter of claim 2 further configured to confirm the set operating mode by transmitting an acknowledgement message to the wireless power receiver in response to the message received the wireless power receiver selecting a power profile corresponding to the operating mode.

4. The wireless power transmitter of claim 2 further configured to request a temporary interruption of wireless power transfer if the message received from the wireless power receiver selecting the power profile corresponding to the operating mode selects an operating mode for which a change of the input DC voltage is desired.

5. The wireless power transmitter of claim 4 further configured to temporarily interrupt wireless power transfer responsive to a message received from the wireless power receiver requesting a temporary interruption of wireless power transfer.

6. The wireless power transmitter of claim 1 further configured to request an operating mode of the wireless power transmitter by sending a message requesting a power profile corresponding to the operating mode to the wireless power receiver.

7. The wireless power transmitter of claim 6 wherein the wireless power transmitter sends a message requesting a light load profile responsive to a high temperature condition of the wireless power transmitter.

8. A wireless power receiver comprising:
a wireless power transfer coil;
a rectifier that receives an input AC voltage induced in the wireless power transfer coil by a wireless power transmitter and outputs a DC voltage; and
a communications module configured to communicate with the wireless power transmitter by transmitting and receiving messages requesting, selecting, or confirming one of a plurality of power profiles of the wireless power transmitter, the plurality of power profiles corresponding to a gain measurement mode, a nominal mode that delivers a relatively higher power level, and a light load mode that delivers a relatively lower power level.

9. The wireless power receiver of claim 8 further configured to send a message selecting an operating mode of the wireless power transmitter responsive to a message received from the wireless power transmitter requesting a power profile corresponding to the operating mode.

10. The wireless power receiver of claim 8 further configured to send a message selecting a power profile corresponding to an operating mode of the wireless power transmitter based at least in part on a state of charge of a battery in the wireless power receiver.

11. The wireless power receiver of claim 10 wherein the wireless power receiver sends a message selecting a power profile corresponding to the light load mode if the state of charge of the battery is high.

12. The wireless power receiver of claim 10 wherein the wireless power receiver sends a message selecting a power profile corresponding to the nominal mode if the state of charge of the battery is low.

13. A method, performed by a wireless power transmitter, the method comprising:
receiving a message from a wireless power receiver selecting a power profile corresponding to an operating mode of the wireless power transmitter;
setting the operating mode of the wireless power transmitter responsive to the received message; and
sending a message to the wireless power receiver confirming the power profile;
wherein the power profile is selected from the group consisting of a gain measurement mode profile, a low power mode profile, and a nominal mode profile.

14. The method of claim 13, further comprising:
prior to receiving the message from the wireless power receiver selecting the power profile corresponding to the operating mode of the wireless power transmitter, sending a message to the wireless power receiver requesting the power profile corresponding to the operating mode of the wireless power transmitter.

15. The method of claim 14, wherein sending a message to the wireless power receiver requesting the power profile corresponding to the operating mode of the wireless power transmitter includes requesting the low power mode profile responsive to a high temperature condition of the wireless power transmitter.

16. The method of claim 14, wherein sending a message to the wireless power receiver requesting the power profile corresponding to the operating mode of the wireless power transmitter includes requesting a temporary interruption of wireless power transfer to allow the wireless power transmitter to change an input voltage of the wireless power transmitter.

17. A method, performed by a wireless power receiver, the method comprising:
sending a message to a wireless power transmitter selecting a power profile corresponding to an operating mode of the wireless power transmitter;
receiving a message from the wireless power transmitter confirming the power profile;
wherein the power profile is selected from the group consisting of a gain measurement mode profile, a low power mode profile, and a nominal mode profile.

18. The method of claim 17, further comprising:
prior to sending the message to the wireless power transmitter selecting the power profile corresponding to the operating mode of the wireless power transmitter, receiving a message from the wireless power transmitter requesting the power profile corresponding to the operating mode of the wireless power transmitter.

19. The method of claim 17, wherein sending a message to the wireless power transmitter selecting the power profile corresponding to the operating mode of the wireless power transmitter includes selecting the low power mode profile responsive to a high state of charge of a battery of the wireless power receiver.

20. The method of claim 17, wherein sending a message to the wireless power transmitter selecting the power profile corresponding to the operating mode of the wireless power transmitter includes selecting the nominal mode profile responsive to a low state of charge of a battery of the wireless power receiver.
